(19) United States
(12) Patent Application Publication
(10) Pub. No.: US 2009/0185213 A1
(43) Pub. Date: Jul. 23, 2009

(54) PRODUCTIVITY OF DIGITAL PRINTING OF JOBS WITH DIFFERENT SIZES OF PAPER

(75) Inventor: Martin Edward Banton, Fairport, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/015,829

(22) Filed: Jan. 17, 2008

(51) Int. Cl. G06F 15/00

(52) U.S. Cl. 358/1.15

(57) ABSTRACT

A method of maximizing usage of a photoreceptor particularly a photoreceptor belt in digital printing by intermixing page images of different sizes on the belt when the user has requested multiple print jobs requiring different sheet sizes, or a single document job requiring sheets of different sizes. If no combination of intermixing different page image sizes will maximize belt usage, the method prints page images of the same size.

### BACKGROUND

The present disclosure relates to digital printing and particularly printing on cut sheets by electrostatic or xerographic processes and more particularly to such printing where it is required within a single job or among multiple jobs to print the page images on different sheet sizes. Such complex printing is available on recent digital print engines having multiple sheet feeders and digital front ends (DFE) capable of processing the page images of the desired different sizes.

Digital print engines of the electrostatic or xerographic type commonly have the page images processed on an endless photoreceptor belt formed of a single piece seamed to provide an endless loop. The endless photoreceptor belt is then typically driven over a pair of spaced rollers to provide a moving flat surface for transferring the page images to the individual media sheets. Typically, the length of the seamed belt is selected so there is maximum usage of the belt when printing the most likely sized images, for example maximizing belt usage for A4 sized images.

In such a print engine, the number of sheets of a given size which may be loaded onto the endless belt is thus a function of the length of the belt minus the width of the belt seam and the dimensions of the individual developed images to be placed on the belt. Where print jobs, such as multiple jobs or a single job employing sheets of a different size are executed, the media sheets of different sizes are thus intermixed on the flat surface of the belt during printing. Because of the different dimensions of the sheets of different sizes, the entire surface of the belt may not be utilized. Thus, it has been desired to provide a way or means of maximizing the usage of the photoreceptor belt in a digital print engine and yet maintain the flexibility of concurrent printing of page images employing different sheet sizes.

### BRIEF DESCRIPTION

The present disclosure addresses the above described problem and provides a method of scheduling the feeding of sheets into a digital print engine for placement on a photoreceptor such as a photoreceptor belt in a manner which maximizes the usage of the photoreceptor belt for the image sizes employed in the print job. One version of the method addresses the print job situation in circumstances where multiple jobs are printed concurrently by feeding sheets of different sizes into the print engine from the feeders and intermixing the page images on the photoreceptor belt for concurrent printing of multiple jobs requiring different image and sheet sizes. A second version of the method addresses the type of print job having a single document employing page images requiring different sizes of media sheets for printing of the document and thus feeding of different size sheets into the print engine and intermixing; and, images of different sizes are concurrently placed on the photoreceptor belt. The method of the present disclosure continuously inquires as to whether a different combination of page images of different sizes that may be scheduled on the photoreceptor belt in order to maximize the usage thereof and includes any new jobs entered into the user job request during the printing process.

### BRIEF DESCRIPTION OF THE DRAWINGS

FIG. 1 is a front isometric elevation view of the belts of FIG. 1;

FIG. 2 includes three plan views of a photoreceptor belt cut at the seam and laid out showing three different image placements thereon;

FIG. 3 is a block flow diagram of one application of the method of the present disclosure for printing multiple print jobs with different image/sheet size requirements; and

FIG. 4 is a block flow diagram of another application of the method for printing a document having page images requiring sheets of different sizes.

### DETAILED DESCRIPTION

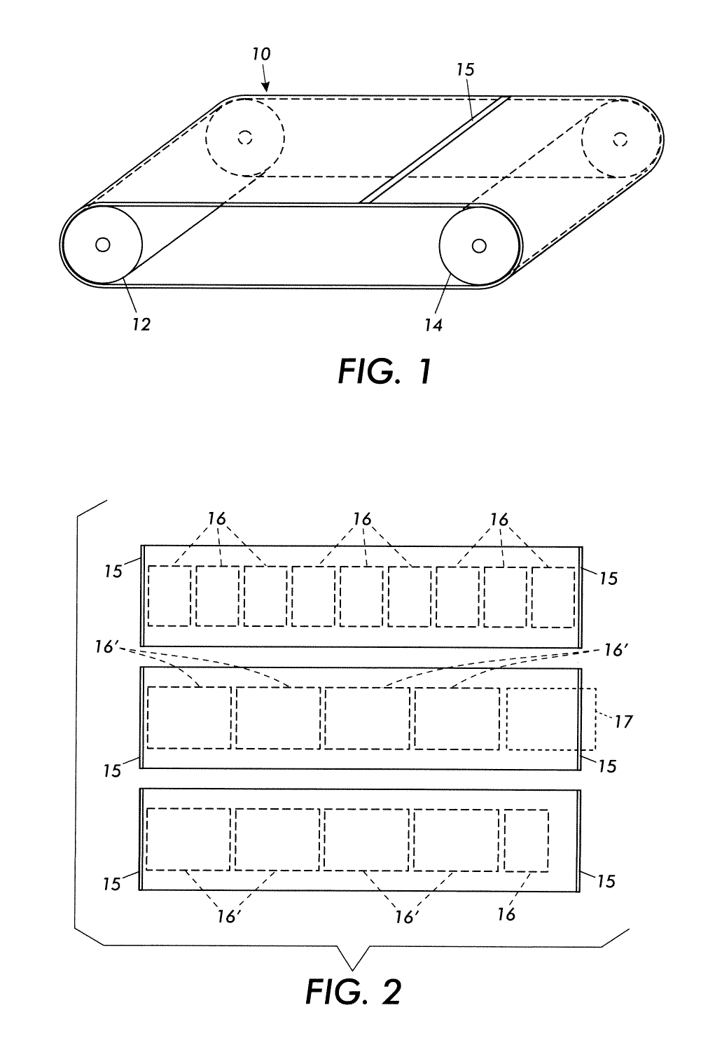

Referring to FIGS. 1 and 2, a photoreceptor such as an endless photoreceptor belt is indicated generally at 10 with a seam 15 formed thereon to form an endless loop is shown in FIG. 1 for running over a pair of spaced rollers 12, 14 to provide an image receiving section of the belt therebetween. The belt 10 may have the images exposed thereon in various combinations and arrangements, one of which is shown in the upper view of FIG. 2, in which the sheets page images are standard letter size denoted 16 disposed on the belt in portrait arrangement with respect to the direction and motion of the belt. The arrangement of the images 16 shows that utilization of the belt is maximized. As denoted in FIG. 2, the page images are placed on the belt with the seam located at either end roller. The middle view of FIG. 2 shows the belt 10 as having disposed thereon larger page images arranged in long edge disposition with respect to the direction and motion of the belt and denoted by reference numeral 16′. As indicated by the dashed line in the middle view of FIG. 2, a final image denoted 17 cannot be disposed on the belt and thus a large area of the belt at the right end thereof is unused. Although a belt type photoreceptor is described, a drum type photoreceptor may also be employed.

Referring to the lower view of FIG. 2, the belt 10 has disposed thereon a combination of the larger images 16′ in long edge disposition and one of the letter size images 16 arranged in short edge disposition to utilize the space which would otherwise be left unfilled; and, this lower view of FIG. 2 represents concurrent printing of either two separate print jobs having requirements for different size print sheets or a single document having page images thereof requiring print sheets of different size.

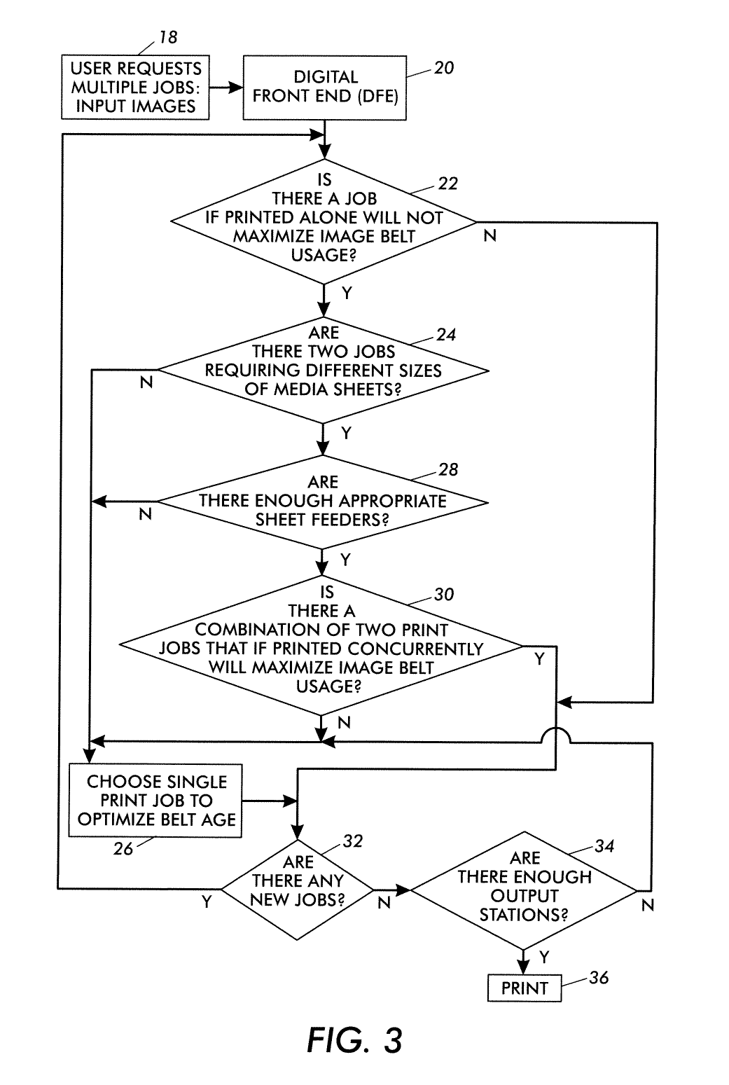

Referring to FIG. 3, the flow diagram of the system operation for determining placement of sheets on the belt 10 is indicated wherein at step 18 the user requests multiple jobs and inputs the digital images to the system. The digital images are then sent to the digital front end (DFE) of the print engine at step 20; and, at step 22 the system queries whether there is a job which, if printed alone, will not maximize image belt usage. If the determination at step 22 is affirmative, the system proceeds to step 24 and queries whether there are two jobs requiring different sizes of media sheets. If the determination in step 24 is negative, the system proceeds to step 26 to choose a single print job to optimize belt usage. If, however, the determination at step 24 is affirmative, the system proceeds to step 28 and queries as to whether there are enough appropriate sheet feeders. If the determination at step 28 is negative, the system proceeds again to step 26 to choose a single print job. If however, the determination at step 28 is affirmative, the system proceeds to step 30 and inquires if there is a combination of two print jobs which, if printed concurrently, will maximize the image belt usage.

If the determination at step 30 is negative, the system again proceeds to step 26 to choose a single print job.

However, if the determination at step 30 is affirmative, the system proceeds to step 32 and inquiries if there are any new print jobs. If the determination at step 32 is affirmative, the system recycles to step 22. The determination at step 32 is also made if a single print job is chosen at step 26, and if the determination at step 22 has been found to be negative.

From step 32, the system proceeds to step 34 and queries whether there are enough output stations. If the answer in step 34 is affirmative, the system proceeds to step 36 and prints. However, if the determination at step 34 is negative, the system returns to step 26.

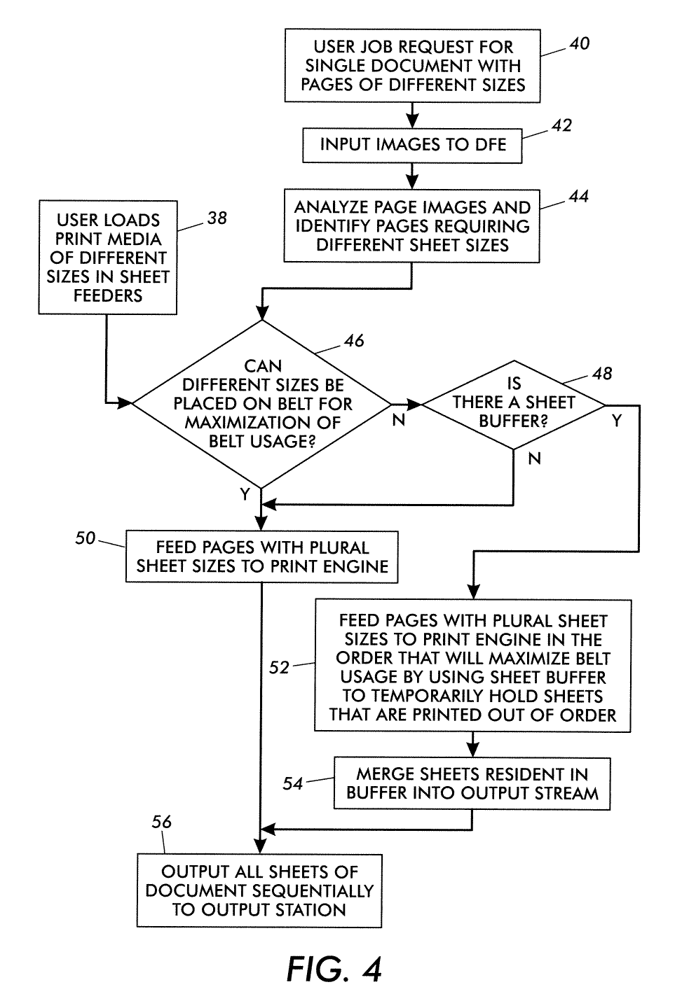

Referring to FIG. 4, the block flow diagram is presented for operation of the system where the user has requested a job of printing a single document with pages of different sizes at step 40; and, at step 42 the page images are inputted into the print engine DFE. The system then proceeds to analyze the page images and identify those pages requiring different sheet sizes at step 44. The system then proceeds to step 46 and queries as to whether different page image sizes can be placed on the belt for maximization of belt usage. At step 38 the user loads the different size sheets in the sheets feeders; and, these sizes are inputted to the query at step 46.

If the inquiry at step 46 is answered in the negative, the system proceeds to inquire at step 48 as to whether there is a sheet buffer; and, if not, the system proceeds as if the determination at step 46 were affirmative and at step 50 feeds pages with the plural sheet sizes to the print engine. However, if the determination at step 48 is affirmative, the system proceeds to step 52 and feeds the pages with plural sheets sizes to the print engine to maximize belt usage by using the sheet buffer to hold sheets that are out of order. The system then proceeds to step 54 to merge the sheets in the appropriate order and then to step 56 to output the sheets of the document sequentially to an output station. The system proceeds from step 50 also to step 56 to output the sheets appropriately.

The present disclosure thus describes a unique and novel method for enabling a digital print engine of the type having an endless photoreceptor belt to print jobs which require print sheet media of different sizes, either within a single document or from multiple print jobs requiring sheets of different sizes. The page images are intermixed on the flat portion of the photoreceptor belt if intermixing will maximize the belt usage. If intermixing is employed, the print sheets are subsequently arranged in the proper combinations or order for outputting from the print engine to an output station. The disclosure thus describes a method which maximizes the usage of the photoreceptor belt irrespective of the dimensions of the sheets of different sizes by mixing the page images where such mixing would result in greater utilization of the surface of the photoreceptor belt.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. a method of digital image printing in a print engine employing at: least one photoreceptor comprising:
(a) providing a plurality of print media sheet feeders and loading them with different sheet sizes;
(b) providing a digital front end (DFE) for the print engine and supplying digital images for at least one printing job to the DFE;
(c) identifying page images requiring different sizes of print media sheets and scheduling printing of such images for maximizing utilization of the photoreceptor; and,
(d) feeding sheets from the sheet feeders according to the scheduling and printing the images on the different sheet sizes.

2. The method defined in claim 1, wherein the step of supplying digital images includes supplying page images from a plurality of print jobs.

3. The method defined in claim 1, wherein the step of supplying page images includes supplying page images requiring print media sheets of different sizes for the pages within a document.

4. The method defined in claim 3, further comprising providing a buffer and outputting selected printed sheets to a buffer.

5. The method defined in claim 4, wherein the step of outputting includes outputting the selected sheets in a predetermined sequence from the buffer.

6. The method defined in claim 1, further comprising providing plural output stations, each receiving printed media sheets.

7. The method defined in claim 1, wherein the step of identifying print jobs includes analyzing all print jobs in the DFE.

8. The method defined in claim 7, wherein the step of scheduling includes scheduling in the print engine.

9. The method defined in claim 1, wherein the step of scheduling printing includes determining if there is a combination of two print jobs that if printed concurrently will maximize photoreceptor usage.

10. The method defined in claim 1, wherein the step of identifying includes determining if there are any new print jobs.

11. A method of digital image printing in a print engine employing at least one photoreceptor comprising:
(a) providing first and second print media sheet feeders and loading them with different print media sheet sizes;
(b) providing a digital front end (DFE) for the print engine and supplying digital images for at least one print job to the DFE;
(c) identifying page images requiring print media sheets of the different sizes;
(d) scheduling printing of such page images for maximum utilization of the photoreceptor; and,
(e) feeding sheets from the first and second feeders according to the scheduling and printing on the different sheet sizes.

12. The method defined in claim 11, wherein the step of identifying print jobs requiring different sheet sizes includes performing the identifying in the DFE.

13. The method defined in claim 11, wherein the step of printing includes delivering printed sheets of the different sizes to plural stations from the print engine.

14. The method defined in claim 11, wherein the step of supplying page images includes supplying page images from a first and second print job.

15. The method defined in claim 11, further comprising providing a buffer and outputting the printed sheets in a predetermined sequence to a common station.

16. The method defined in claim 11, wherein the step of identifying page images includes identifying a document having page images requiring print media sheets of different sizes.

17. The method defined in claim 11, wherein the step of scheduling printing includes determining if there is a combination of two print jobs that if printed concurrently will maximize photoreceptor usage.

18. The method defined in claim 11, wherein the step of identifying includes determining if there are any new print jobs.

19. The method defined in claim 11, wherein the step of scheduling includes scheduling for maximum utilization of a photoreceptor belt.
